(19) United States
(12) Patent Application Publication
(10) Pub. No.: US 2026/0196751 A1
(43) Pub. Date: Jul. 9, 2026

(54) BOARD CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventor: Yicheng CHEN, Mie (JP)

(21) Appl. No.: 18/866,071

(22) PCT Filed: Apr. 28, 2023
(86) PCT No.: PCT/JP2023/016838

§ 371 Date: Nov. 15, 2024

(30) Foreign Application Priority Data
May 19, 2022 (JP) 2022-082120

(51) Int. Cl. H01R 12/57; H01R 43/02

(52) U.S. Cl. CPC H01R 12/57; H01R 43/0256

(57) ABSTRACT

A board connector includes a housing and a peg made of metal, to be mounted on an outer wall surface of the housing and fixed to a circuit board by solder. The peg includes a narrow space in the form of a slit open toward the circuit board, and enables the entrance of the solder in a molten state on the circuit board into the narrow space by a capillary phenomenon. An alloy layer made of the solder and the peg is formed on a facing surface of the peg facing the circuit board and the inner surface of the narrow space, and this alloy layer contributes to improving a fixing force of the peg to the circuit board.

### TECHNICAL FIELD

The present disclosure relates to a board connector.

### BACKGROUND

Patent Document 1 discloses a board connector including a housing to be arranged on a surface of a board and pegs assembled with the housing. The peg includes a body portion to be assembled with a side wall of the housing and a folded portion extending in parallel to the board from the lower end edge of the body portion. The peg is fixed to the board by a solder portion interposed between the folded portion and the board.

### PRIOR ART DOCUMENT

### Patent Document

Patent Document 1: JP 2019-036477 A

### SUMMARY OF THE INVENTION

### Problems to be Solved

To enhance a fixing force of the peg to the board, an area of the folded portion parallel to the board may be increased. However, if the area of the folded portion is increased, there is a problem that a space for a circuit and a mounting area for electronic components on the board are reduced.

A board connector of the present disclosure was completed on the basis of the above situation and aims to reduce an occupied area of a peg on a circuit board.

### Means to Solve the Problem

The present disclosure is directed to a board connector with a housing and a peg made of metal, the peg being mounted on an outer wall surface of the housing, the peg being fixed to a circuit board by solder, the peg including a narrow space in the form of a slit open toward the circuit board, the narrow space enabling entrance of the solder in a molten state on the circuit board into the narrow space by a capillary phenomenon.

### Effect of the Invention

According to the present disclosure, it is possible to reduce an occupied area of a peg on a circuit board.

### BRIEF DESCRIPTION OF THE DRAWINGS

FIG. 1 is a perspective view of a board connector of a first embodiment mounted on a circuit board when viewed obliquely from behind.

FIG. 2 is a perspective view of a peg mounted on an outer wall surface on a right side of a housing when viewed obliquely from behind.

FIG. 3 is a perspective view of a peg mounted on an outer wall surface on a left side of the housing when viewed obliquely from behind.

FIG. 4 is a front view in section showing a state where the peg is mounted on the outer wall surface on the right side of the housing.

FIG. 5 is a partial enlarged section of FIG. 4.

FIG. 6 is a front view in section showing a state where a peg to be compared is mounted on the outer wall surface on the right side of the housing.

FIG. 7 is a partial enlarged section of FIG. 6.

FIG. 8 is a front view in section showing a state where a peg of a second embodiment is mounted on an outer wall surface on a right side of a housing.

### DETAILED DESCRIPTION TO EXECUTE THE INVENTION

### Description of Embodiments of Present Disclosure

First, embodiments of the present disclosure are listed and described below.
(1) The board connector of the present disclosure is provided with a housing and a peg made of metal, the peg being mounted on an outer wall surface of the housing, the peg being fixed to a circuit board by solder, the peg including a narrow space in the form of a slit open toward the circuit board, the narrow space enabling entrance of the solder in a molten state on the circuit board into the narrow space by a capillary phenomenon. According to the configuration of the present disclosure, an alloy layer made of the solder and the peg is formed on a facing surface of the peg facing the circuit board and the inner surface of the narrow space. This alloy layer contributes to improving a fixing force of the peg to the circuit board. Since the alloy layer in the narrow space extends in a direction away from the circuit board, an area of the facing surface of the peg facing the circuit board can be suppressed to be small. In this way, an occupied area of the peg on the circuit board can be reduced.
(2) Preferably, in (1), the narrow space is formed between two plate portions arranged in a plate thickness direction. According to this configuration, the peg is easily formed as compared to the case where a narrow space is formed in one thick plate-like portion or in one block-like part.
(3) Preferably, in (1) or (2), an entrance blocking surface intersecting an entering direction of the solder in the narrow space is provided in a back end part of the narrow space on a side opposite to the circuit board. According to this configuration, the solder in the molten state having entered the narrow space is held in close contact with the entrance blocking surface, whereby a large formation range of the alloy layer in the narrow space can be ensured.
(4) Preferably, in (3), the entrance blocking surface extends in a direction oblique to the entering direction of the solder in the narrow space. According to this configuration, since a width of the narrow space is gradually narrowed toward a back end in a region of the narrow space where the entrance blocking surface is formed, the solder in the molten state can reliably enter to the back end of the narrow space.
(5) Preferably, in (1) to (4), the facing surface of the peg facing the circuit board includes a semicircular surface region. According to this configuration, when a case where the facing surface of the peg facing the circuit board is a flat surface facing in parallel to the circuit board and a case where the facing surface of the peg facing the circuit board is a semicircular surface are compared, a projection area of the facing surface on the circuit board is smaller when the facing surface is the semicircular surface than when the facing surface is the flat surface under a condition that the both facing surfaces have the same area. Therefore, the occupied area of the peg on the circuit board can be reduced by providing the semicircular surface region.

### Details of Embodiments of Present Disclosure

### First Embodiment

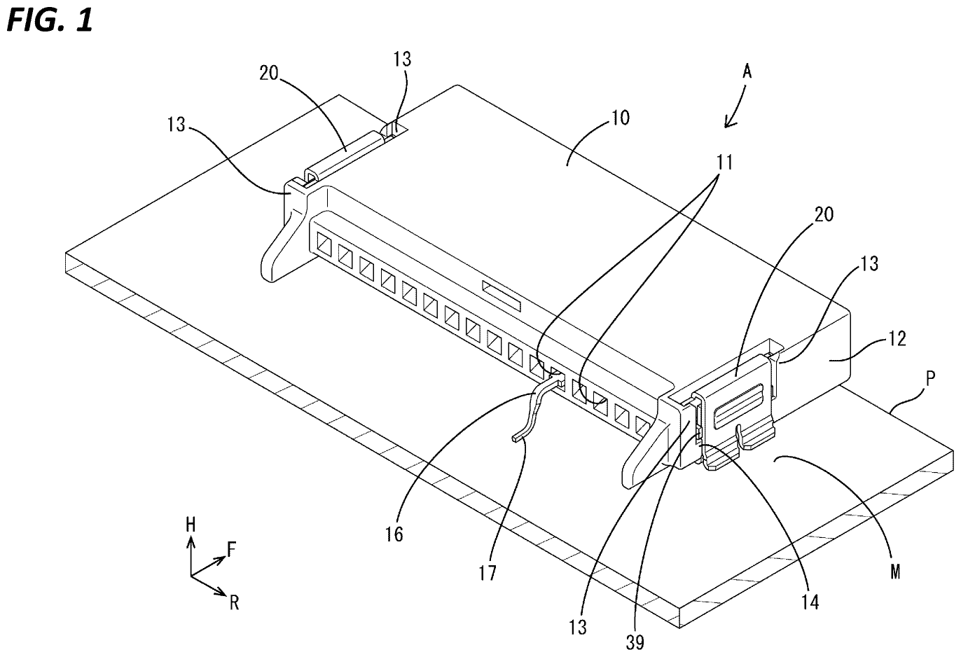

A board connector A of a specific first embodiment of the present disclosure is described below with reference to FIGS. 1 to 5. The present invention is not limited to these illustrations, but is represented by claims and intended to include all changes in the scope of claims and in the meaning and scope of equivalents. In the first embodiment, a direction F in FIGS. 1 to 3 is defined as a forward direction concerning a front-rear direction. A direction R in FIGS. 1 to 5 is defined as a rightward direction concerning a lateral direction. The lateral direction and a width direction are used as synonyms. A direction H in FIGS. 1 to 5 is defined as an upward direction concerning a vertical direction. The vertical direction and a height direction are used as synonyms.

As shown in FIG. 1, the board connector A of the first embodiment is configured by assembling one housing 10, a plurality of terminal fittings 16 and a pair of bilaterally symmetrical pegs 20. The board connector A is fixed to a mounting surface M (upper surface) of a horizontally arranged circuit board P using solder S. With the board connector A fixed to the circuit board P, the height direction is a direction perpendicular to the mounting surface M of the circuit board P.

The housing 10 is a rectangular parallelepiped having a height (dimension in the vertical direction) smaller than a depth (dimension in the front-rear direction) and a width (dimension in the lateral direction). A plurality of terminal accommodation chambers 11 arranged in the lateral direction are formed in the housing 10. The terminal fitting 16 is mounted into each terminal accommodation chamber 11 from behind the housing 10. A board connecting portion 17 formed in a rear end part of the terminal fitting 16 is fixed to the mounting surface M of the circuit board P.

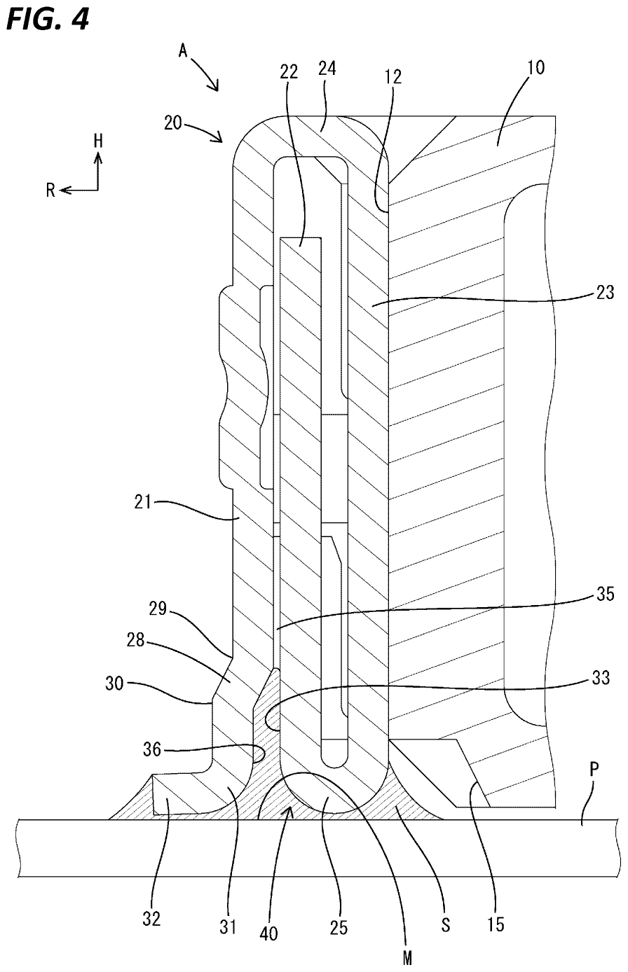

A pair of press-fit portions 13 spaced apart in the front-rear direction are formed in each of outer wall surfaces 12 in both left and right end parts of the housing 10. In a plan view of the housing 10, the press-fit portion 13 projects from the outer wall surface 12 and is bent into an L shape. Stoppers 14 shaped to project toward the mating press-fit portions 13 in the plan view are formed in lower end parts of the pair of press-fit portions 13. As shown in FIG. 4, a cut portion 15 open in the bottom surface of the housing 10 is formed in each of lower end parts of both left and right outer wall surfaces 12 of the housing 10. The cut portion 15 is formed over an entire range from the front press-fit portion 13 to the rear press-fit portion 13.

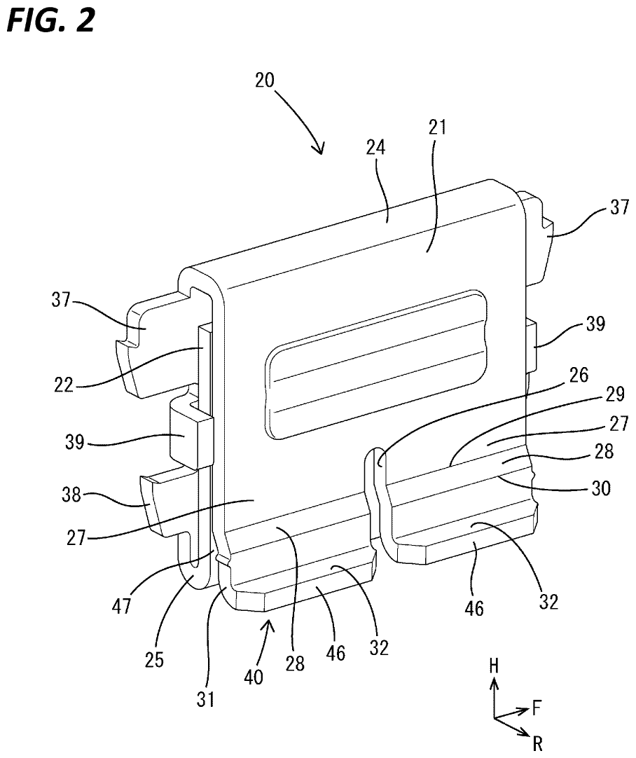

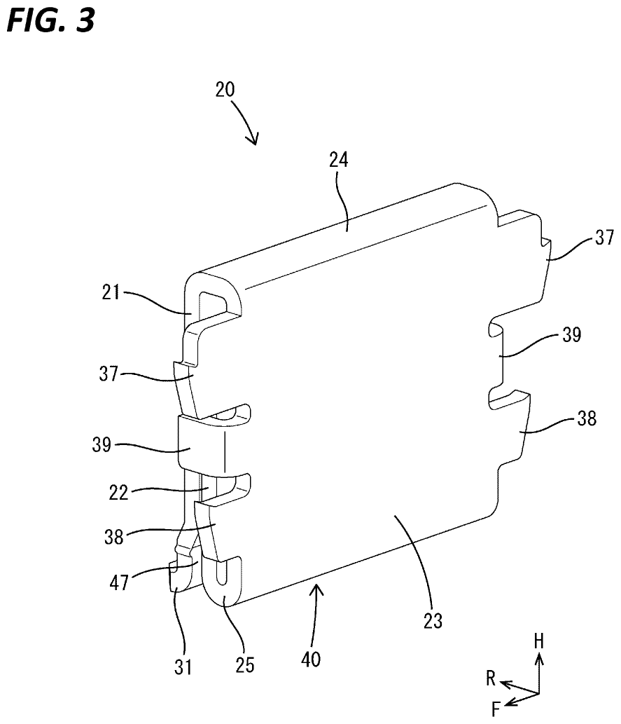

The peg 20 is a single component formed by bending one metal plate material. As shown in FIGS. 2 and 3, the peg 20 includes an outer plate portion 21, a middle plate portion 22, an inner plate portion 23, an upper folded portion 24 and a lower folded portion 25. The outer plate portion 21, the middle plate portion 22 and the inner plate portion 23 are arranged side by side in the width direction with plate thickness directions oriented in the width direction. The outer plate portion 21 is arranged at a position most distant from the outer wall surface 12 of the housing 10. The inner plate portion 23 is arranged at a position closest to the outer wall surface 12. The middle plate portion 22 is arranged between the outer plate portion 21 and the inner plate portion 23. The upper end edge of the outer plate portion 21 and that of the middle plate portion 22 are connected via the upper folded portion 24. The lower end edge of the inner plate portion 23 of that of the middle plate portion 22 are connected via the lower folded portion 25. In a front view of the peg 20, the lower folded portion 25 has a semicircular shape.

A lower end part of the outer plate portion 21 is divided into a pair of front and rear leg portions 27 by a slit-like splitting groove 26. Each leg portion 27 is formed with a step portion 28 extending in the front-rear direction. The step portion 28 includes an upper fold 29 extending in the front-rear direction and a lower fold 30 extending in the front-rear direction. The outer surface of the upper fold 29 is a valley fold recessed at an obtuse angle in a front view. The outer surface of the lower fold 30 is a mountain fold projecting at an obtuse angle in the front view. Out of the outer plate portion 21 (leg portion 27), a part above the step portion 28 and a part below the step portion 28 are parallel. A bent portion 31 having a quarter-circular front view shape is formed on a lower end edge part of each leg portion 27. The bent portion 31 projects outward (toward a side opposite to the inner plate portion 23 in the width direction) from the outer side surface of the leg portion 27. Each leg portion 27 is formed with a projecting portion 32 in the form of a rib projecting outward from the projecting end edge of the bent portion 31.

As shown in FIGS. 3 and 4, the peg 20 is formed with a pair of front and rear narrow spaces 33 defined by the middle plate portion 22 and the pair of leg portions 27. A formation range of the narrow space 33 in the height direction (vertical direction) is a region between the upper end of the bent portion 31 (lower folded portion 25) and the upper fold 29 (upper end of the step portion 28). The upper end of the narrow space 33 communicates with a very narrow space 35 between the outer plate portion 21 and the middle plate portion 22 via a very narrow opening 34 in the form of a slit open in the front-rear direction. Widths of the very narrow opening 34 and the very narrow space 35 are set to be narrow enough to prevent the entrance of the solder S in a molten state into the narrow space 33 by a capillary phenomenon.

The lower end of the narrow space 33 is open in the lower surface (bottom surface) of the peg 20 as a slit-like entrance opening 36 in the front-rear direction. With the peg 20 joined to the circuit board P, the narrow space 33 is facing the mounting surface M via the entrance opening 36. A width of the entrance opening 36 is larger than that of the very narrow opening 34 and set to enable the entrance of the solder S in the molten state into the narrow space 33 by the capillary phenomenon.

As shown in FIGS. 2 and 3, a first projection 37 projecting forward or rearward and a second projection 38 arranged below the first projection 37 and projecting forward or rearward are formed on each of both front and rear end edge parts of the inner plate portion 23. A hooking portion 39 is formed at a height between the first and second projections 37, 38 on each of the both front and rear end edge parts of the inner plate portion 23. In a plan view, the hooking portions 39 are bent into an L shape and project outward in the width direction from the both front and rear end edge parts of the inner plate portion 23.

The peg 20 is mounted on the housing 10 by press-fitting the first and second projections 37, 38 into the press-fit portions 13 from above the housing 10. The hooking portions 39 are hooked to the stoppers 14 from above, whereby the peg 20 is positioned in the height direction with respect to the housing 10. The lower folded portion 25 is arranged to cover the cut portion 15 from the width direction. A part of the lower folded portion 25 is facing the cut portion 15.

By interposing the solder S between the pegs 20 and the mounting surface M, the housing 10 is fixed to the circuit board P. The peg 20 has a joint surface 40 for joining the solder S. The joint surface 40 is composed of a facing surface 41 of the peg 20 facing the mounting surface M of the circuit board P, and a non-facing surface 45 of the peg 20 not facing the mounting surface M. In the first embodiment, “facing” means facing the mounting surface M in a direction orthogonal to the mounting surface M, and the facing surface 41 includes both a region at an angle nearly parallel to the mounting surface M and a region oblique to the mounting surface M.

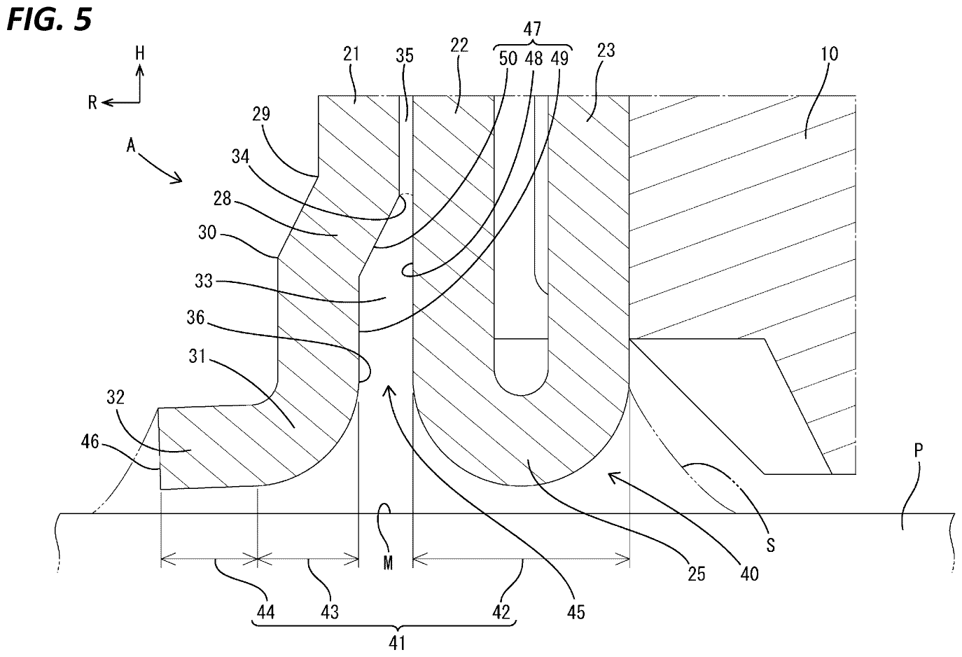

As shown in FIG. 5, the facing surface 41 is composed of a semicircular surface region 42, a quarter-circular surface region 43 and a plane region 44. The semicircular surface region 42 is a surface outside a bend in the lower folded portion 25. A front view shape of the semicircular surface region 42 is semicircular. The quarter-circular surface region 43 is a surface outside a bend in the bent portion 31. A front view shape of the quarter-circular surface region 43 is quarter-circular. The plane region 44 is the lower surface of the projecting portion 32. A front view shape of the plane region 44 is linear.

The non-facing surface 45 is composed of a projecting end surface 46 and a space inner surface 47 in the narrow space 33. The projecting end surface 46 is a tip surface of the projecting portion 32 in a projecting direction. The space inner surface 47 is composed of an internal narrow inner surface 48, an external narrow inner surface 49 and an entrance blocking surface 50. The internal narrow inner surface 48 is a surface facing the narrow space 33, out of the inner plate portion 23. A formation range of the internal narrow inner surface 48 in the height direction is a region from the upper end of the semicircular surface region 42 (lower folded portion 25) to the upper end of the narrow space 33 (upper folded portion 24). The external narrow inner surface 49 and the entrance blocking surface 50 are surfaces facing the inside of the narrow space 33, out of the outer plate portion 21. A formation range of the external narrow inner surface 49 in the height direction is a region between the upper end of the quarter-circular surface region 43 (bent portion 31) and the lower end of the step portion 28. A formation range of the entrance blocking surface 50 in the height direction is a region between the upper end of the external narrow inner surface 49 (lower end of the step portion 28) and the upper end of the narrow space 33 (upper end of the step portion 28). The upper end of the external narrow inner surface 49 and the lower end of the entrance blocking surface 50 are connected at an obtuse angle.

In a front view, the entrance blocking surface 50 is oblique to the height direction of the peg 20. Out of the narrow space 33, a region below the entrance blocking surface 50 has a constant width. A width of a region of the narrow space 33 where the entrance blocking surface 50 is formed is gradually reduced from the lower end toward the upper end of the entrance blocking surface 50. A width of the narrow space 33 is smallest at the upper end (back end) of the narrow space 33.

In fixing the board connector A to the circuit board P, paste of the solder S is applied to the mounting surface M and the pegs 20 are placed on the paste of the solder S. If the circuit board P and the board connector A are accommodated into a reflow furnace (not shown) and heated in this state, the solder S melted by being heated is joined to the joint surfaces 40 of the pegs 20. At this time, an alloy layer (not shown) made of the metal as a material of the peg 20 and the solder S in the molten state is formed on the entire joint surface 40. The larger an area of the alloy layer, the higher a fixing force of the peg 20 to the circuit board P.

On the facing surface 41, out of the joint surface 40, the solder S is present to be sandwiched between the facing surface 41 and the mounting surface M. Fillets are formed in the quarter-circular surface region 43 and the semicircular surface region 42 of the facing surface 41. Fillets are also formed on the projecting end surface 46 of the non-facing surface 45. The solder S in the molten state is sucked up by a capillary phenomenon and enters the narrow space 33. The solder S is filled in the entire narrow space 33 and held in close contact with the internal narrow inner surface 48, the external narrow inner surface 49 and the entrance blocking surface 50 to form the alloy layer. Since the upper end of the narrow space 33 communicates with the very narrow space 35 via the very narrow opening 34 and both front and rear ends of the narrow space 33 are open to both front and rear end surfaces of the peg 20, air does not stay in an upper end part of the narrow space 33. In this way, the solder S is held in close contact with the entire space inner surface 47 in the narrow space 33.

An opening area (entrance opening 36) of the narrow space 33 is relatively small as compared to the mounting surface M, but an area of the space inner surface 47 in the narrow space 33 (height of the narrow space 33) is sufficiently larger than an opening area of the entrance opening 36. The alloy layer formed on the space inner surface 47 in the narrow space 33 (solder S having entered the narrow space 33) enhances the fixing strength of the peg 20 to the mounting surface M. By forming the narrow space 33, the narrowing of the area of the facing surface 41 is realized while desired fixing strength (area of the joint surface 40) by the solder S is ensured. The facing surface 41 of the peg 20 is a region directly projected on the mounting surface M when the peg 20 is viewed from a direction perpendicular to the mounting surface M. A projection range of this facing surface 41 is an occupied range (mounting range) of the peg 20 on the mounting surface M. In contrast, the non-facing surface 45 is a region not projected on the mounting surface M when the peg 20 is viewed from the direction perpendicular to the mounting surface M. Therefore, even if the area of the non-facing surface 45 is large, the mounting range (mounting area) of the peg 20 on the mounting surface M is not increased. In this way, sufficient fixing strength is ensured even if the mounting area of the peg 20 is not increased.

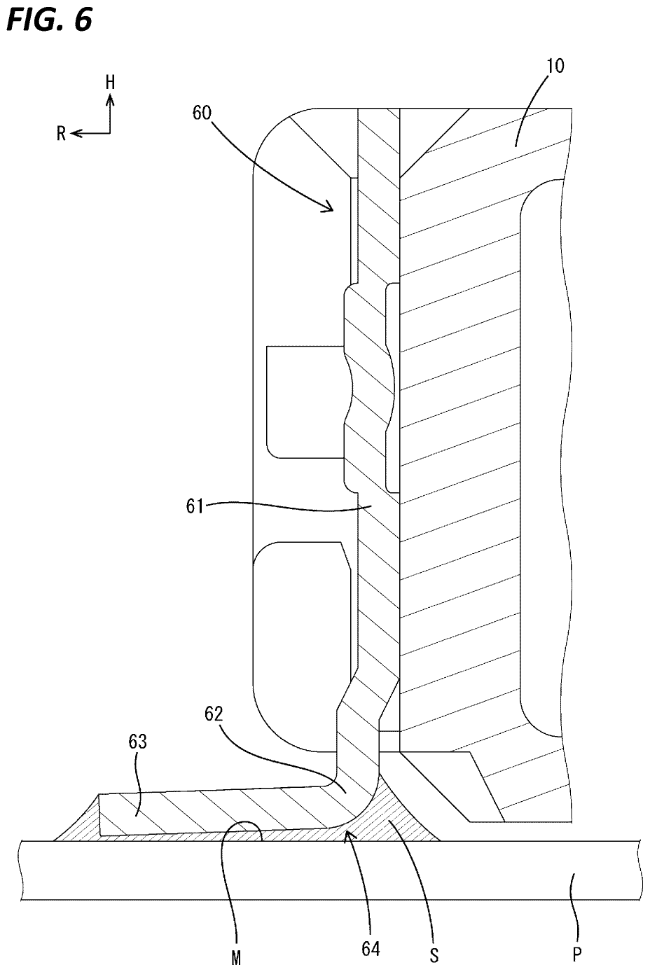

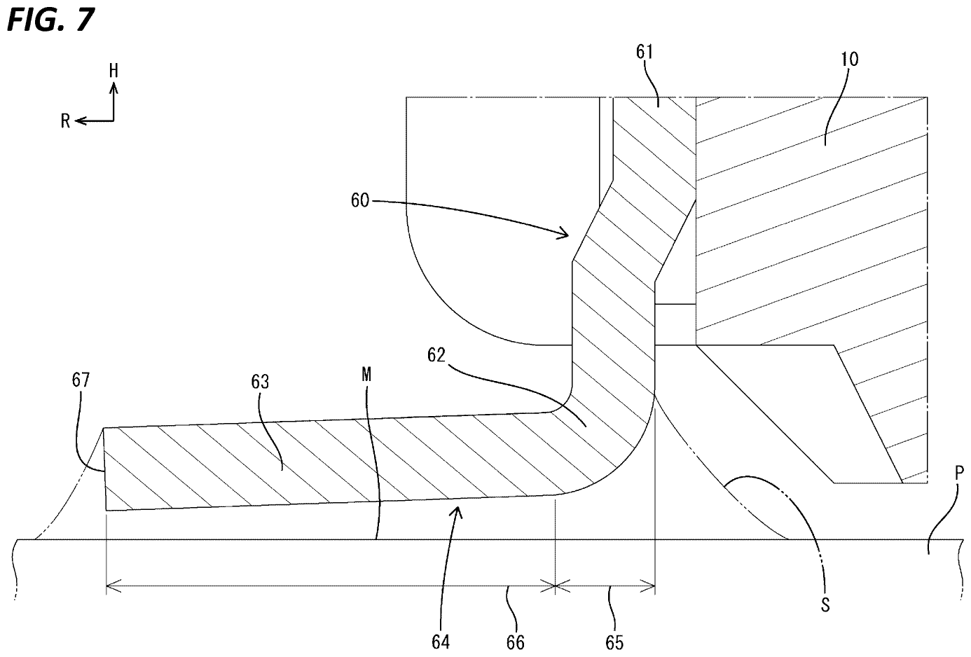

Under a condition that the desired fixing strength (area of the joint surface 40) using the solder S is the same, the mounting area of the peg 20 of the first embodiment formed with the narrow space 23 on the mounting surface M and a mounting area of a peg 60 to be compared and not formed with the narrow space 33 on the mounting surface M are compared. The peg 60 to be compared shown in FIGS. 6 and 7 includes one single plate portion 61 having a plate thickness direction oriented in the width direction, a curved portion 62 having a quarter-circular shape and projecting from the lower end edge of the single plate portion 61 and an extending portion 63 in the form of a flat plate extending from the bent portion 31 along the mounting surface M. A joint surface 64 of the peg 60 to be compared is composed of a quarter-circular curved surface 65 outside a bend in the curved portion 62, a lower surface 66 of the extending portion 63 and an extending end surface 67 of the extending portion 63.

Out of the peg 60 to be compared, only the extending end surface 67 constitutes a non-facing region not facing the mounting surface M. In contrast, out of the peg 20 of the first embodiment, the non-facing surface 45 not facing the mounting surface M is composed of the projecting end surface 46 of the projecting portion 32 and the space inner surface 47 of the narrow space 33. If the area of the extending end surface 67 and that of the projecting end surface 46 are equal, the area of the facing surface 41 can be reduced by the area of the space inner surface 47 in the peg 20 of the first embodiment. That is, a width of the projecting portion 32 can be made smaller than that of the extending portion 63. Further, since the semicircular surface region 42 of the facing surface 41 is constituted by a curved surface, the width direction can be reduced as compared to the case where the semicircular surface region 42 is constituted by a flat surface. In this way, it is realized to make the width direction of the peg 20 smaller than the width of the peg 60 to be compared.

The board connector A of the first embodiment is provided with the housing 10 and the pegs 20. The pegs 20 are components made of metal and mounted on the both left and right outer wall surfaces 12 of the housing 10. The peg 20 is fixed to the mounting surface M of the circuit board P by the solder S. The peg 20 has the narrow spaces 33. The narrow space 33 is in the form of a slit open toward the circuit board P and extends in a direction away from the circuit board P. The solder S in the molten state on the circuit board P can enter the narrow space 33 by the capillary phenomenon.

The alloy layer (not shown) made of the solder S and the peg 20 is formed on the facing surface 41 of the peg 20 facing the circuit board P and the inner surface (space inner surface 47) of the narrow space 33. This alloy layer contributes to improving the fixing force of the peg 20 to the circuit board P. Since the alloy layer in the narrow space 33 extends in the direction away from the circuit board P, the area of the facing surface 41 of the peg 20 facing the circuit board P can be suppressed to be small. In this way, the occupied area of the peg 20 on the circuit board P can be reduced.

The narrow space 33 is formed between two plate portions (outer plate portion 21 and middle plate portion 22) arranged in the plate thickness direction. The peg 20 is easily formed as compared to the case where the narrow space 33 is formed in one thick plate-like portion or one block-like part.

The entrance blocking surface 50 intersecting an entering direction of the solder S in the narrow space 33 is provided on a back side part of the narrow space 33 on a side opposite to the circuit board P. The solder S in the molten state having entered the narrow space 33 is held in close contact with the entrance blocking surface 50, whereby a large area (formation range) of the alloy layer in the narrow space 33 is ensured. The entrance blocking surface 50 extends in a direction oblique to the entering direction of the solder S in the narrow space 33. Since the width of the narrow space 33 is gradually narrowed toward the back end in a region of the narrow space 33 where the entrance blocking surface 50 is formed, the solder S in the molten state can reliably enter to the back end of the narrow space 33.

The peg 20 is formed by bending a metal plate material. The facing surface 41 of the peg 20 facing the mounting surface M of the circuit board P includes the semicircular surface region 42. If the plane region 44 facing at an angle nearly parallel to the circuit board P and the semicircular surface region 42, out of the facing surface 41 of the peg 20 facing the circuit board P, have the same area and are compared, a projection area of the semicircular surface region 42 on the circuit board P (mounting surface M) is smaller than that of the plane region 44. That is, when a case where the facing surface 41 of the peg 20 facing the circuit board P is a flat surface facing in parallel to the circuit board P and a case where a facing surface of the peg 20 facing the circuit board P is a semicircular surface are compared, the projection area of the facing surface 41 on the circuit board P is smaller when the facing surface 41 is the semicircular surface than when the facing surface 41 is the flat surface under a condition that the both facing surfaces 41 have the same area. Therefore, the occupied area of the peg 20 on the circuit board P can be reduced by providing the semicircular surface region 42.

### Second Embodiment

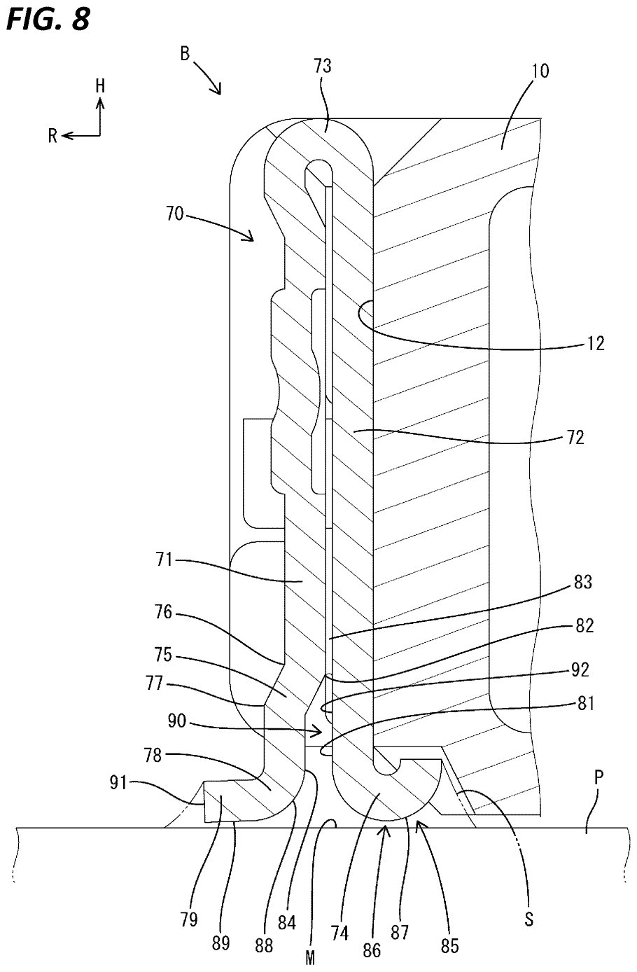

A board connector B of a second specific embodiment of the present disclosure is described with reference to FIG. 8. The board connector B of the second embodiment differs from the first embodiment in the configuration of a peg 70. Since the other configuration is the same as in the first embodiment, the same components are denoted by the same reference signs and the structures, functions and effects thereof are not described.

The peg 70 of the second embodiment is a single component formed by bending one metal plate material. The peg 70 includes an outer plate portion 71, an inner plate portion 72, an upper folded portion 73 and a lower folded portion 74. The outer plate portion 71 and the inner plate portion 72 are arranged side by side in a width direction with plate thickness directions oriented in the width direction. The outer plate portion 71 is arranged at a position distant from an outer wall surface 12 of a housing 10, and the inner plate portion 72 is arranged at a position close to the outer wall surface 12. The upper end edge of the outer plate portion 71 and that of the inner plate portion 72 are connected via the upper folded portion 73.

The outer plate portion 71 is formed with a step portion 75 extending in a front-rear direction as in the first embodiment. The step portion 75 is constituted by an upper fold 76 in the front-rear direction at an obtuse angle in a front view and a lower fold 77 in the front-rear direction likewise at an obtuse angle in the front view. A lower end edge part of the outer plate portion 71 is formed with a bent portion 78 having a quarter-circular shape in the front view. The bent portion 78 projects outward (toward a side opposite to the inner plate portion 72 in the width direction) from the outer side surface of the outer plate portion 71. The outer plate portion 71 is formed with a projecting portion 79 in the form of a rib projecting outward from the projecting end edge of the bent portion 78.

The peg 70 is formed with a narrow space 81 defined by the outer plate portion 71 and the inner plate portion 72. A formation range of the narrow space 81 in a height direction (vertical direction) is a region between the upper end of the bent portion 78 and the upper fold 76 (upper end of the step portion 75). The upper end of the narrow space 81 communicates with a very narrow space 83 between the outer plate portion 71 and the inner plate portion 72 via a very narrow opening 82 in the form of a slit open in the front-rear direction. Widths of the very narrow opening 82 and the very narrow space 83 are set to be narrow enough to prevent the entrance of solder S in a molten state by a capillary phenomenon. The lower end of the narrow space 81 is open in the lower surface (bottom surface) of the peg 70 as an entrance opening 84 in the form of a slit in the front-rear direction. With the peg 70 joined to a circuit board P, the narrow space 81 is facing a mounting surface M via the entrance opening 84. A width of the entrance opening 84 is larger than that of the very narrow opening 82 and is set to enable the entrance of the solder S in the molten state into the narrow space 81 by the capillary phenomenon.

By interposing the solder S between the pegs 70 and the mounting surface M, a housing 10 is fixed to the circuit board P. A joint surface 85 of the peg 70 is composed of a facing surface 86 facing the mounting surface M of the circuit board P and a non-facing surface 90 not facing the mounting surface M. The facing surface 86 is composed of a semicircular surface region 87, a quarter-circular surface region 88 and a plane region 89. The semicircular surface region 87 is a surface outside a bend in the lower folded portion 74. The quarter-circular surface region 88 is a surface outside a bend in the bent portion 78. The plane region 89 is the lower surface of the projecting portion 79. The non-facing surface 90 is composed of a projecting end surface 91 and a space inner surface 92 in the narrow space 81. The projecting end surface 91 is a tip surface of the projecting portion 79 in a projecting direction. The space inner surface 92 is composed of an internal narrow inner surface, an external narrow inner surface and an entrance blocking surface as in the first embodiment. By forming the narrow space 81, the narrowing of an area of the facing surface 86 is realized while desired fixing strength (joint area) by the solder S is ensured.

### Other Embodiments

The present invention is not limited to the above described and illustrated embodiments, but is represented by claims. The present invention includes all changes in the scope of claims and in the meaning and scope of equivalents and includes also the following embodiments.

Although the peg is configured by arranging three plate portions in the width direction in the first embodiment and by arranging two plate portions in the width direction in the second embodiment, the peg may be composed of four or more plate portions.

Although the narrow space is formed between the plurality of plate portions in the first and second embodiments, the narrow space may be formed in one thick plate portion or in one block-like part.

Although the narrow space extends in the direction perpendicular to the mounting surface of the circuit board in the first and second embodiment, the narrow space may extend in a direction oblique to the mounting surface of the circuit board.

Although the entrance blocking surface is formed in the narrow space in the first and second embodiments, the entrance blocking surface may not be formed and the narrow space may extend further upward than a maximum entrance height of the solder.

Although the entrance blocking surface is a surface oblique to the entering direction of the solder in the narrow space in the first and second embodiments, the entrance blocking surface may be a surface perpendicular to the entering direction of the solder in the narrow space.

Although the facing surface of the peg facing the circuit board includes the semicircular surface region in the first and second embodiments, the facing surface of the peg facing the circuit board may not include the semicircular surface region.

Although the entrance blocking surface is formed only on the outer plate portion in the first embodiment, the entrance blocking surface may be formed on both the outer plate portion and the middle plate portion or may be formed on the middle plate portion.

Although the entrance blocking surface is formed only on the outer plate portion in the second embodiment, the entrance blocking surface may be formed on both the outer plate portion and the inner plate portion or may be formed on the inner plate portion.

### LIST OF REFERENCE NUMERALS

A . . . board connector
B . . . board connector
M . . . mounting surface
P . . . circuit board
S . . . solder
10 . . . housing
11 . . . terminal accommodation chamber
12 . . . outer wall surface
13 . . . press-fit portion
14 . . . stopper
15 . . . cut portion
16 . . . terminal fitting
17 . . . board connecting portion
20 . . . peg
21 . . . outer plate portion
22 . . . middle plate portion
23 . . . inner plate portion
24 . . . upper folded portion
25 . . . lower folded portion
26 . . . splitting groove
27 . . . leg portion
28 . . . step portion
29 . . . upper fold
30 . . . lower fold
31 . . . bent portion
32 . . . projecting portion
33 . . . narrow space
34 . . . very narrow opening
35 . . . very narrow space
36 . . . entrance opening
37 . . . first projection
38 . . . second projection
39 . . . hooking portion
40 . . . joint surface
41 . . . facing surface
42 . . . semicircular surface region
43 . . . quarter-circular surface region
44 . . . plane region
45 . . . non-facing surface
46 . . . projecting end surface
47 . . . space inner surface (inner surface of narrow space)
48 . . . internal narrow inner surface
49 . . . external narrow inner surface
50 . . . entrance blocking surface
60 . . . peg to be compared
61 . . . single plate portion
62 . . . curved portion
63 . . . extending portion
64 . . . joint surface
65 . . . quarter-circular curved surface
66 . . . lower surface
67 . . . extending end surface
70 . . . peg
71 . . . outer plate portion
72 . . . inner plate portion
73 . . . upper folded portion
74 . . . lower folded portion
75 . . . step portion
76 . . . upper fold
77 . . . lower fold
78 . . . bent portion
79 . . . projecting portion
81 . . . narrow space
82 . . . very narrow opening
83 . . . very narrow space
84 . . . entrance opening
85 . . . joint surface
86 . . . facing surface
87 . . . semicircular surface region
88 . . . quarter-circular surface region
89 . . . plane region
90 . . . non-facing surface
91 . . . projecting end surface
92 . . . space inner surface

1. A board connector, comprising:
a housing; and
a peg made of metal, the peg being mounted on an outer wall surface of the housing, the peg being fixed to a circuit board by solder,
the peg including:
a narrow space in the form of a slit open toward the circuit board, the narrow space enabling entrance of the solder in a molten state on the circuit board into the narrow space by a capillary phenomenon; and
a very narrow space narrow enough to prevent the entrance of the solder in the molten state by the capillary phenomenon, and
a back end part of the narrow space on a side opposite to the circuit board communicating with the very narrow space.

2. The board connector of claim 1, wherein the narrow space is formed between two plate portions arranged in a plate thickness direction.

3. The board connector of claim 1, wherein an entrance blocking surface intersecting an entering direction of the solder in the narrow space is provided in a back end part of the narrow space on a side opposite to the circuit board.

4. The board connector of claim 3, wherein the entrance blocking surface extends in a direction oblique to the entering direction of the solder in the narrow space.

5. The board connector of claim 1, wherein a facing surface of the peg facing the circuit board includes a semicircular surface region.

6. The board connector of claim 3, wherein a facing surface of the peg facing the circuit board includes a semicircular surface region.
